(19) United States
(12) Patent Application Publication
(10) Pub. No.: US 2026/0142342 A1
(43) Pub. Date: May 21, 2026

(54) BATTERY CELL

(71) Applicant: TECHTRONIC CORDLESS GP, Anderson, SC (US)

(72) Inventors: Dan GENG, Dongguan City (CN); Denis Gaston FAUTEUX, Hong Kong (CN); Jin Wei LI, Dongguan City (CN); Chi LIANG, Dongguan City (CN)

(21) Appl. No.: 19/121,367

(22) PCT Filed: Nov. 10, 2022
(86) PCT No.: PCT/CN2022/131144

§ 371 Date: Apr. 15, 2025

(51) Int. Cl. H01M 50/528; H01M 10/04; H01M 50/107; H01M 50/533; H01M 50/536; H01M 50/538; H01M 50/56

(52) U.S. Cl. CPC H01M 50/528; H01M 10/0422; H01M 50/107; H01M 50/533; H01M 50/536; H01M 50/538; H01M 50/56

(57) ABSTRACT

Embodiments provide a battery cell having a cylindrical housing with a first end and a second end opposite the first end, wherein the second end is enclosed. The battery cell also includes an electrode assembly positioned within the housing between the first end and the second end. The electrode assembly includes an anode, a cathode, and one or more separator sheets. The battery cell further includes a conductor configured to electrically couple one of the anode or the cathode to the housing. The conductor includes a first side facing the electrode assembly, a second side opposite the first side and facing the housing, and an embossed portion for improving a welding operation for welding the conductor to the housing.

### BACKGROUND

Batteries are critical in providing power to many electrical devices that are relied upon daily. Cylindrical batteries with a rolled arrangement (i.e., jelly roll battery cells) are commonly used to power electrical devices. A rolled cylindrical battery generally includes an electrode assembly comprising an anode, a separator, and a cathode cylindrically rolled together in concentric layers and placed into a battery housing with electrical terminals provided at either end of the housing. Typical battery cells, and particularly tabless battery cells often include a current collector or weld plate that are used as a bridging component to provide an electrical connection between the electrode assembly and a corresponding battery terminal. The current collector plate is typically welded to the interior of the battery cell housing. With limited access to the components of the battery cell, it can be difficult to achieve and/or verify a weld between the current collector plate and the battery cell housing.

### SUMMARY

One embodiment provides a battery cell having a cylindrical housing with a first end and a second end opposite the first end, wherein the second end is enclosed. The battery cell also includes an electrode assembly positioned within the housing between the first end and the second end. The electrode assembly includes an anode, a cathode, and one or more separator sheets. The battery cell further includes a conductor configured to electrically couple one of the anode or the cathode to the housing. The conductor includes a first side facing the electrode assembly, a second side opposite the first side and facing the housing, and an embossed portion for improving a welding operation for welding the conductor to the housing.

In one aspect, the cathode, the anode, and the one or more separator sheets are rolled in concentric layers about a central aperture.

In another aspect, the embossed portion is positioned at an approximate center of the conductor and is coaxial with the central aperture.

In another aspect, the embossed portion is positioned on the second side of the conductor and includes a number of convex portions.

In another aspect, a subset of the convex portions are configured to melt and weld the conductor to the housing in response to a welding head applying an electrical voltage to the first side of the conductor thereby causing an electrical current to flow through the conductor to the housing.

In another aspect, the subset of convex portions configured to melt is dependent on a duration of time that the electrical voltage is applied to the first side of the conductor.

In another aspect, the embossed portion is formed by applying a force to the first side of the conductor.

In another aspect, the electrode assembly further includes a cathode rubbing portion at the first end and an anode rubbing portion at the second end, wherein the conductor is configured to electrically couple the anode rubbing portion to the housing.

In another aspect, the conductor includes three outer edges having a first width, each outer edge separated by an arc having a first radius, wherein the first width is between 3.00 millimeters and 10.00 millimeters, and the first radius is between 4.00 millimeters and 12.00 millimeters.

In another aspect, a total width of the conductor is between 1.50 millimeters and 4.50 millimeters.

In another aspect, a total length of the conductor is between 1.50 millimeters and 4.50 millimeters.

In another aspect, a thickness of the conductor at an area including the embossed portion is between 0.10 millimeters and 0.30 millimeters, and a thickness of the conductor at an area not including the embossed portion is between 0.05 millimeters and 0.15 millimeters.

In another aspect, a diameter of each of the plurality of convex portions is between 0.15 millimeters and 0.45 millimeters.

In another aspect, a width of the embossed portion is between 1.50 millimeters and 4.50 millimeters.

In another aspect, the embossed portion is formed into a square matrix of convex portions.

In another aspect, the embossed portion is formed in a circular matrix of convex portions.

In another aspect, the embossed portion is formed into one or more linear matrices of convex portions.

Another embodiment provides a battery cell having a cylindrical housing with a first end and a second end opposite the first end, wherein the second end is enclosed. The battery cell also includes an electrode assembly positioned within the housing between the first end and the second end. The electrode assembly includes an anode, a cathode, and one or more separator sheets. The battery cell further includes a conductor configured to electrically couple one of the anode or the cathode to the housing. The conductor includes a first side facing the electrode assembly, a second side opposite the first side and facing the housing, and an embossed portion. The embossed portion is positioned on the second side of the conductor and includes a number of convex portions and a number of concave portions. A subset of the convex portions are configured to melt and weld the conductor to the housing in response to a welding head performing a welding operation.

In one aspect, the conductor is a current collection plate.

In another aspect, the welding operation is a resistance welding operation.

Other aspects of the invention will become apparent by consideration of the detailed description and accompanying drawings.

### BRIEF DESCRIPTION OF THE DRAWINGS

FIG. 1 is an exploded perspective view of a battery cell, according to some embodiments.

FIG. 2 is a plan view of an anode, a cathode, and a separator included in the battery cell of FIG. 1, according to some embodiments.

FIG. 3 is a cross sectional view of the battery cell of FIG. 1, according to some embodiments.

FIG. 4A is a plan view of a current collection plate, useable with the battery cell of FIG. 1, according to some embodiments.

FIG. 4B is a side view of the current collection plate of FIG. 4A, according to some embodiments.

FIG. 5 is a plan view of a current collection plate having an alternative embossed portion arrangement, useable with the battery cell of FIG. 1, according to some embodiments.

FIG. 6 is a plan view of a current collection plate having a further alternative embossed portion arrangement, useable with the battery cell of FIG. 1, according to some embodiments.

FIG. 7 is a plan view of a current collection plate having a further alternative embossed portion arrangement, useable with the battery cell of FIG. 1, according to some embodiments.

FIG. 8A is a plan view of an embossed portion included in the current collection plate of FIGS. 4A and 4B, according to some embodiments.

FIG. 8B is a side view of the embossed portion included in the current collection plate of FIGS. 4A and 4B, according to some embodiments.

FIG. 9 is a cross-sectional perspective view of the current collection plate of FIGS. 4A and 4B, taken along section A-A of FIG. 1, undergoing a welding operation, according to some embodiments.

FIG. 10 is a flowchart illustrating a method for connecting electrical elements of a battery cell, according to some embodiments.

### DETAILED DESCRIPTION

Before any embodiments are explained in detail, it is to be understood that the embodiments are not limited in its application to the details of the configuration and arrangement of components set forth in the following description or illustrated in the accompanying drawings. The embodiments are capable of being practiced or of being carried out in various ways. Also, it is to be understood that the phraseology and terminology used herein are for the purpose of description and should not be regarded as limiting. The use of “including,” “comprising,” or “having” and variations thereof are meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings.

In addition, it should be understood that embodiments may include hardware, software, and electronic components or modules that, for purposes of discussion, may be illustrated and described as if the majority of the components were implemented solely in description, would recognize that, in at least one embodiment, the electronic-based aspects may be implemented in software (e.g., stored on non-transitory computer-readable medium) executable by one or more processing units, such as a microprocessor and/or application specific integrated circuits (“ASICs”). As such, it should be noted that a plurality of hardware and software-based devices, as well as a plurality of different structural components, may be utilized to implement the embodiments. For example, “servers,” “computing devices,” “controllers,” “processors,” etc., described in the specification can include one or more processing units, one or more computer-readable medium modules, one or more input/output interfaces, and various connections (e.g., a system bus) connecting the components.

Relative terminology, such as, for example, “about,” “approximately,” “substantially,” etc., used in connection with a quantity or condition would be understood by those of ordinary skill to be inclusive of the stated value and has the meaning dictated by the context (e.g., the term includes at least the degree of error associated with the measurement accuracy, tolerances [e.g., manufacturing, assembly, use, etc.] associated with the particular value, etc.). Such terminology should also be considered as disclosing the range defined by the absolute values of the two endpoints. For example, the expression “from about 2 to about 4” also discloses the range “from 2 to 4”. The relative terminology may refer to plus or minus a percentage (e.g., 1%, 5%, 10%, or more) of an indicated value.

It should be understood that although certain drawings illustrate hardware and software located within particular devices, these depictions are for illustrative purposes only. Functionality described herein as being performed by one component may be performed by multiple components in a distributed manner. Likewise, functionality performed by multiple components may be consolidated and performed by a single component. In some embodiments, the illustrated components may be combined or divided into separate software, firmware and/or hardware. For example, instead of being located within and performed by a single electronic processor, logic and processing may be distributed among multiple electronic processors. Regardless of how they are combined or divided, hardware and software components may be located on the same computing device or may be distributed among different computing devices connected by one or more networks or other suitable communication links. Similarly, a component described as performing particular functionality may also perform additional functionality not described herein. For example, a device or structure that is “configured” in a certain way is configured in at least that way but may also be configured in ways that are not explicitly listed.

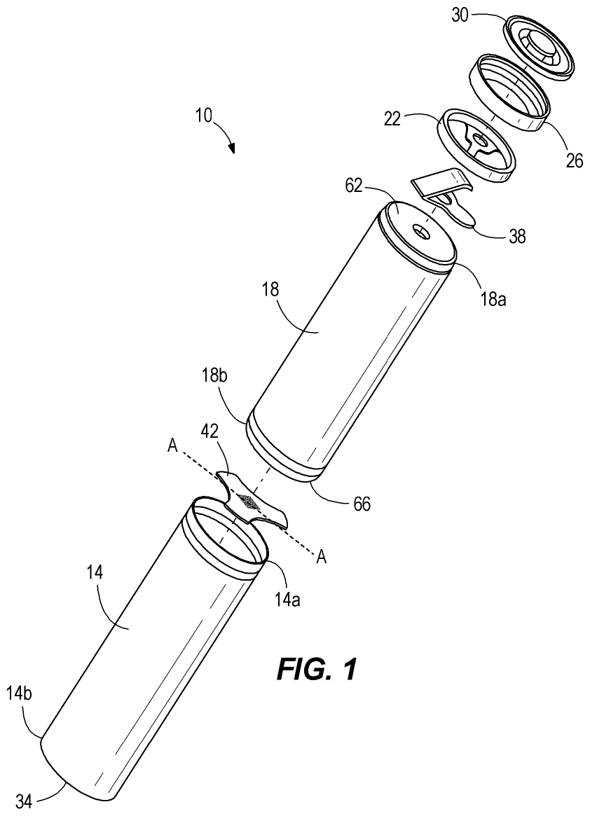

FIG. 1 illustrates a battery cell 10 according to some embodiments. The battery cell 10 includes a housing 14, an electrode assembly 18 positioned within the housing 14, a first insulating member 22, and a second insulating member 26. The battery cell 10 further includes a first terminal 30 positioned at a first end 14a of the housing 14, a second terminal 34 positioned at a second end 14b of the housing 14, a first conductor 38 positioned in the housing 14 between the electrode assembly 18 and the first terminal 30, and a second conductor 42 positioned in the housing 14 between the electrode assembly 18 and the second terminal 34. In the illustrated embodiment, the first conductor 38 is a formable (e.g., bendable, malleable, manipulatable, etc.) current collection plate, current collector, and/or the like that is configured to electrically couple the electrode assembly 18 to the first terminal 30. Similarly, the second conductor 42 is a formable (e.g., bendable, malleable, manipulatable, etc.) current collection plate, current collector, and/or the like that is configured to electrically couple the electrode assembly 18 to the second terminal 34.

As illustrated in FIG. 1, the housing 14 generally provides a casing for the electrical elements (e.g., electrode assembly 18, first terminal 30, second terminal 34, first conductor 38, second conductor 42, and/or the like) of the battery cell 10. In some embodiments, some or all of the electrical elements are seated within the housing 14. In the illustrated embodiment, the housing 14 is be made of an insulative material, such as plastic or another non-conductive material. In some embodiments, the housing 14 may be made of a conductive material, such as steel, aluminum, or another conductive metal. In some embodiments, the second end 14b is enclosed and the housing 14 functions as a negative terminal to facilitate an external connection for the battery cell 10. For example, the second terminal 34 may be integrated into the housing 14 at the second end 14b.

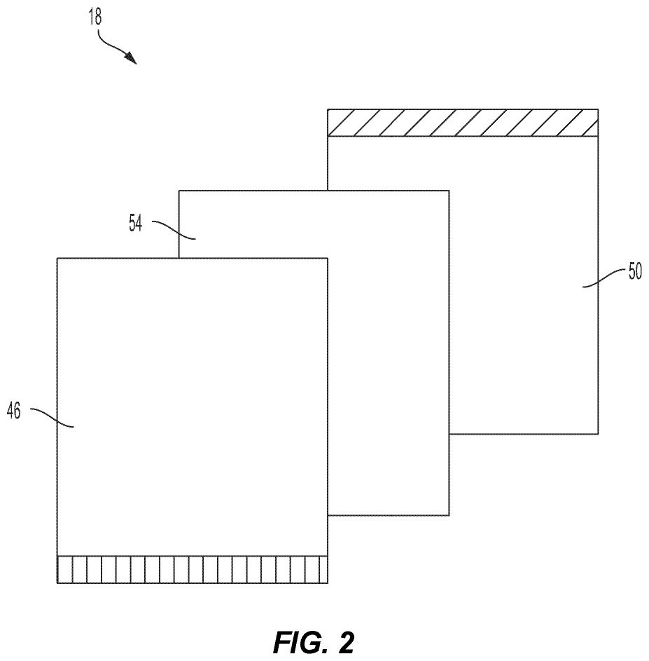

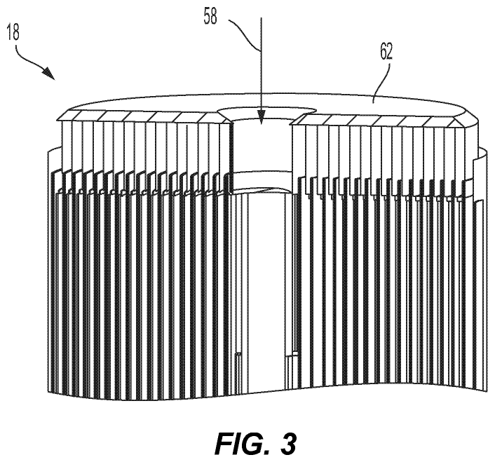

Referring now to FIG. 2 with brief reference to FIG. 3, the electrode assembly 18 includes an anode 46, a cathode 50, and one or more separators 54 positioned between the anode 46 and the cathode 50. In the illustrated embodiment, the anode 46 includes an anode sheet, the cathode 50 includes a cathode sheet, and the separator 54 includes an insulator or separator sheet. As shown in FIG. 3, the sheets may be rolled in concentric layers about a central aperture 58 of the electrode assembly 18 to form a jelly roll. In some embodiments, the electrode assembly 18 is wound around a center pin which may be removed after completion of the winding operation. In some embodiment, the cathode 50 can provided with a tab(s).

Referring again to FIG. 1, once wound, a first end 18a and a second end 18b of the electrode assembly 18 may include exposed or uncoated portions of the anode 46 and the cathode 50. The exposed portions at the first end 18a may be rubbed down to a flat, rough surface to form a first rubbing portion 62, and the exposed portions at the second end 18b may be rubbed down to a flat, rough surface to form a second rubbing portion 66. In some embodiments, the first rubbing portion 62 is a cathode rubbing portion, and the second rubbing portion 66 is an anode rubbing portion. The first rubbing portion 62 provides a landing surface for the first conductor 38 such that the first conductor 38 may be coupled (e.g., welded, affixed, adhered, fastened, etc.) to the electrode assembly 18. Similarly, the second rubbing portion 66 provides a connection for the second conductor 42, as will be discussed in greater detail below. Therefore, the first conductor 38 may be configured to electrically couple the first rubbing portion 62 to the first end 14a of the housing 14, and the second conductor 42 may be configured to electrically couple the second rubbing portion 66 to the second end 14b of the housing 14. In some embodiment, if the cathode is provided with a tab, the cathode will not be rubbed to form the rubbing portion, and the first conductor 38 can be omitted and the tab can directly attached to the terminal 30.

In some embodiments, the electrode assembly 18 may have a nominal voltage between approximately 1 V and approximately 5 V, and a nominal capacity between about 1 Ah and about 5 Ah or more (e.g., up to about 9 Ah). The electrode assembly 18 may have any rechargeable chemistry type, such as, for example Lithium (“Li”), Lithium-ion (“Li-ion”), other Lithium-based chemistry, Nickel-Cadmium (“NiCd”), Nickel-metal Hydride (“NiMH”), etc. In the illustrated embodiment, the first terminal 30 is a positive terminal and the second terminal 34 is a negative terminal.

In some embodiments, the first insulating member 22 is made of plastic and/or rubber. The first insulating member 22 may be provided with through holes 70 that allow the first conductor 38 to extend through the first insulating member 22 and contact the first terminal 30. The first rubbing portion 62 may be arranged or seated in the first insulating member 22 to prevent contact between the first rubbing portion 62 and the housing 14. The first terminal 30 may then be arranged in the second insulating member 26 that is supported on the first insulating member 22. In some embodiments, the first insulating member 22 and the second insulating member 26 are crimped over the first terminal 30 once the electrode assembly 18 and other electrical elements are arranged in the housing 14.

Referring still to FIG. 1, the first terminal 30 may provide electrical contact to an external device in order to provide electrical power to the external device from the electrode assembly 18. In the illustrated embodiment, the first terminal 30 may receive power from an external device to recharge the electrode assembly 18. In some embodiments, the first terminal 30 is a positive terminal electrically connected to a positive electrode sheet (e.g., anode 46) within the electrode assembly 18, and the second terminal 34 is a negative terminal connected to a negative sheet (e.g., cathode 50). For example, the first terminal 30 may connect the anode 46 of the electrode assembly 18 to a positive terminal of an external device that is to be powered by the battery cell 10. In some embodiments, the first terminal 30 is made of metal, such as stainless steel.

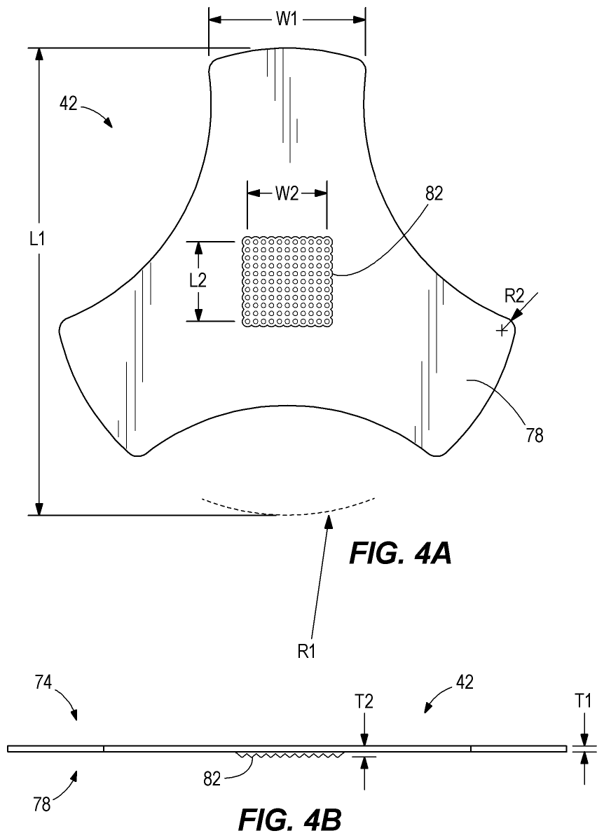

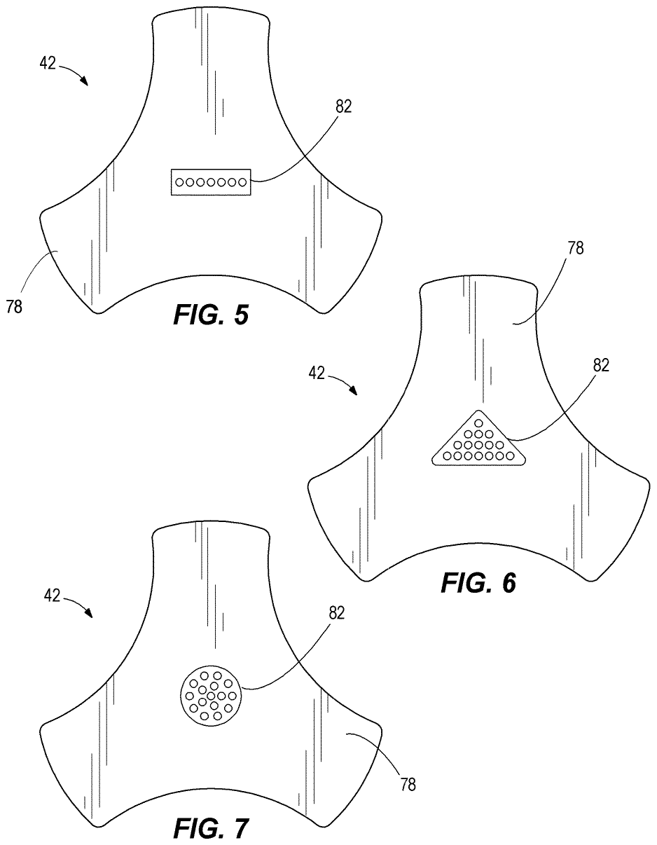

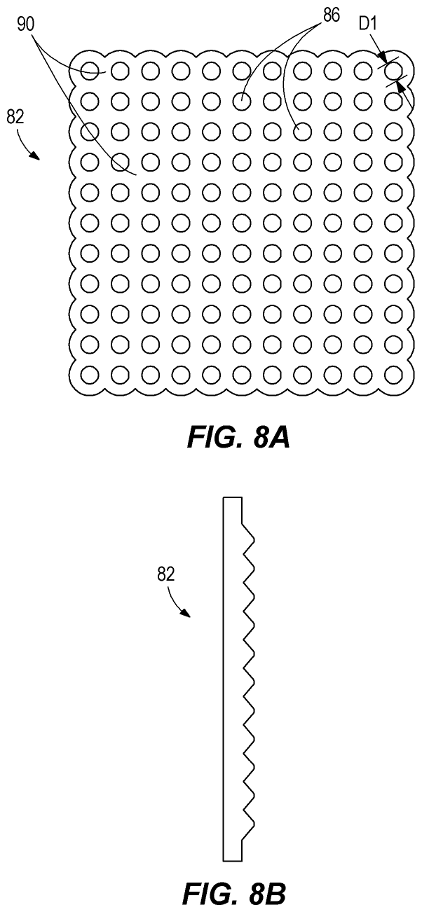

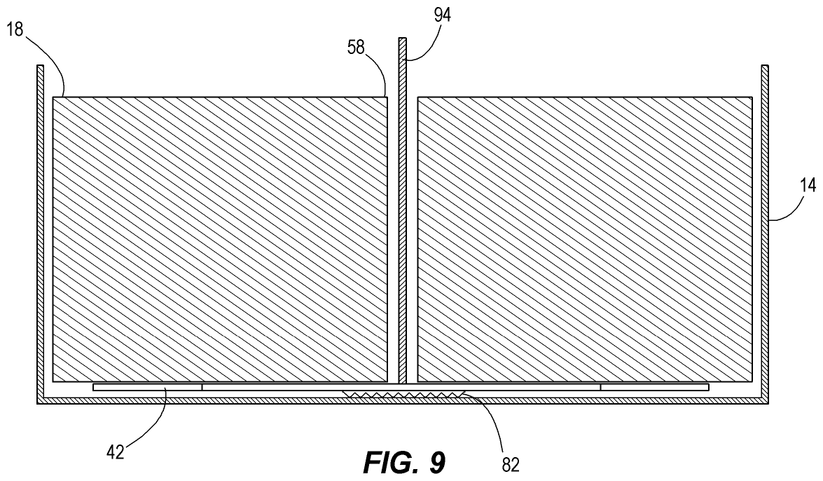

Referring now to FIGS. 4A-5B the second conductor 42 includes a first side 74 and a second side 78 opposite the first side 74. The second conductor 42 may be coupled to the second end 18b of the electrode assembly 18 such that the first side 74 of the second conductor 42 faces the electrode assembly 18. The second side 78 faces the second end 14b of the housing 14 and is configured to connect the second end 18b of the electrode assembly 18 to the second end 14b of the housing 14. The second side 78 of the second conductor 42 may include an embossed portion 82 for improving a welding operation for welding the second conductor 42 to the housing 14. In some embodiments, the embossed portion 82 is positioned at an approximate center of the second side 78 of the second conductor 42, coaxial with the central aperture 58. The embossed portion 82 may have multiple convex portions 86. The embossed portion 82 may also have multiple concave portions 90. The second conductor 42 may be stamped or otherwise embossed with the convex portions 86 and the concave portions 90. The convex portions 86 and the concave portions 90 may be formed on the second conductor 42 such that each concave portion 90 is defined by the space between adjacent convex portions 86. Each of the convex portions 86 and the concave portions 90 may be of approximately equal size. The convex portions 86 may be formed by welding solders on the second conductor 42. In some embodiments, the embossed portion 82 is a separate member welded to the second conductor 42. As illustrated in FIG. 8B, in some embodiments, the embossed portion 82 may have a saw-shaped cross-section, however, the cross-section of the embossed portion 82 may be any suitable shape.

The convex portions 86 may be arranged in rows and columns within the embossed portion 82 such that an outer perimeter of the embossed portion 82 is approximately square-shaped. In the illustrated embodiments, the embossed portion 82 includes 121 convex portions 86 arranged in eleven rows and eleven columns. However, the number of convex portions 86 is not limited to 121, and the number of rows and columns are not limited to eleven each. For example, the embossed portion 82 may include forty-nine convex portions 86 arranged in seven rows and seven columns. In some embodiments, the embossed portion 82 may include sixteen convex portions 86 arranged in four rows and four columns. In some embodiments, the number of convex portions 86 included in each row or column varies by row or column as required for a given application.

For example, as illustrated in FIGS. 5-7, respectively, the number of convex portions 86 included in each row and column may vary such that an outer perimeter of the embossed portion 82 is formed in a linear pattern (FIG. 5), a triangular pattern (FIG. 6), or a circular pattern (FIG. 7). In some examples, the number of convex portions 86, and the arrangement thereof, may be configured as required for a given application. The above configurations are for exemplary purposes and should not be considered limiting for purposes of this disclosure. For example, in some implementations, the convex portions 86 may be arranged in a random pattern. Alternatively, the convex portions 86 may be arranged in pentagonal patterns, hexagonal patterns, octagonal patterns, etc. In other embodiments, the second conductor 42 may include multiple embossed portions 82. The multiple embossed portions 82 may each include convex portions 86 arranged in similarly shaped patterns. In other examples, the multiple embossed portions 82 may each include convex portions 86 arranged in differently shaped patterns, as required for a given application.

The convex portions 86 may be formed by protrusions protruding from a surface of the second conductor 42. The concave portions 90 may be formed by the surface of the second conductor 42. The embossed portion 82 may be formed from the same material or different material from the second conductor 42. For example, one or both of the second conductor 42 and the embossed portion 82 may be formed from nickel. In some embodiments, one or both or the second conductor 42 and the embossed portion 82 are formed from copper and include a nickel coating.

FIG. 9 illustrates a cross sectional view of the battery cell 10 undergoing a welding operation for electrically coupling the second end 18b of the electrode assembly 18 to the second end 14b of the battery cell housing 14. During the welding operation, the electrode assembly 18 and the second conductor 42 are seated in the battery cell housing 14, and a welding head 94 is inserted through the central aperture 58 of the electrode assembly 18. The welding head 94 may be inserted through the central aperture 58 at the first end 18a of the electrode assembly 18 towards the second end 18b of the electrode assembly 18 such that the welding head 94 contacts the first side 74 of the second conductor 42. A subset of the convex portions 86 on the second side 78 of the second conductor 42 is configured to melt and weld the second conductor 42 to the second end 14b of the battery cell housing 14 in response to the welding head 94 performing a welding operation. The welding operation may include applying an electrical voltage to the first side 74 of the second conductor 42, thereby causing an electrical current to flow through the second conductor 42 to the housing 14. In some examples, the welding head 94 is a resistance welding head.

The subset of convex portions 86 configured to melt may be dependent on multiple factors, such as a duration of time of the welding operation (e.g., the duration of time that the electrical current is applied to the first side 74 of the second conductor 42), a magnitude of electrical current applied to the first side 74 of the second conductor 42, or a combination thereof. However, in some examples other parameters or factors may affect the melting of the convex portions 86 and/or the overall weld of the second conductor to the second end 14b of the battery cell housing 14. In some embodiments, the subset of convex portions 86 configured to melt includes all of the convex portions 86. In some embodiments, the subset of convex portions 86 configured to melt includes at least half of the convex portions 86. In some embodiments, the subset of convex portions 86 configured to melt includes less than half of the convex portions 86. The convex portions 86 positioned nearest the approximate center of the second conductor 42 may be configured to melt first during the welding operation. Therefore, when the subset of convex portions 86 configured to melt is less than the total number of convex portions 86 included in the embossed portion 82, the subset includes the most centrally located convex portions 86.

The subset of convex portions 86 configured to melt such that the required peel-off force of the second conductor 42, is increased. Further, the melting of all or a subset of the convex portion reduces resistance in the battery cell 10 between the housing 14 and the second conductor 42.

Compared to a flat current collection plate, the convex portions 86 formed on the second conductor 42 melt more efficiently, as the convex portions 86 provide a higher resistance between the second conductor 42 and the battery housing 14 which, in turn, generates more heat when the current flows through the convex portions 86. Therefore, the likelihood of a failed welding procedure is reduced. Additionally, the embossed portions 82 provides decreased resistance in the battery cell 10 as many of both the subset convex portions 86 configured to melt and the remaining convex portions 86 remain in contact with the battery cell housing 14 after the welding process.

Referring again to FIGS. 4A and 4B, possible dimensions of the second conductor 42 are also illustrated. The second conductor 42 may have outer edges having a width W1. In the illustrated embodiment, the second conductor 42 has three outer edges defined by the width W1 and separated by an arc (e.g., length between two outer edges) having a radius R1. Each of the outer edges may have a curve defined by the radius R2. In some embodiments, the width W1 is between approximately 3.00 mm and approximately 10.00 mm (e.g., approximately 6.00 mm). However, values of less than 3.00 mm and more than 10.00 mm are also contemplated as required for a given application. In some embodiments, the radius R1 is between approximately 4.00 mm and approximately 12.00 mm (e.g., approximately 8.00 mm). In some embodiments, the radius R2 is between approximately 0.25 mm and approximately 0.75 mm (e.g., approximately 0.50 mm). However, values of less than 0.25 mm and more than 0.75 mm are also contemplated as required for a given application.

The second conductor 42 may have a total length L1 defined between a center of one of the arcs and one of the outer edges on a side of the second conductor 42 opposite the arc. In some embodiments, the length L1 is between approximately 14.00 mm and approximately 22.00 mm (e.g., approximately 18.00 mm). However, values of less than 14.00 mm and more than 22.00 mm are also contemplated as required for a given application.

The embossed portion 82 may have a total width W2 and a total length L2. In some embodiments, the total width W2 of the embossed portion 82 is between approximately 1.50 mm and approximately 4.50 mm (e.g., approximately 3.00 mm). However, values of less than 1.5 mm and more than 4.50 mm are also contemplated as required for a given application. In some embodiments, the total length L2 of the embossed portion 82 is between approximately 1.50 mm and approximately 4.50 mm (e.g., approximately 3.00 mm). However, values of less than 1.50 mm and more than 4.50 mm are also contemplated as required for a given application.

Each of the convex portions 86 may have a diameter of D1 (FIG. 8A). In some embodiments, the diameter D1 is between approximately 0.15 mm and approximately 0.45 mm (e.g., approximately 0.30 mm). However, values of less than 0.15 mm and more than 0.45 mm are also contemplated as required for a given application.

As illustrated in FIG. 4B, the second conductor 42 may have a first thickness T1 and a second thickness T2. The first thickness T1 may be the thickness of the second conductor 42 at an area of the conductor 42 not including the embossed portion 82. The second thickness T2 may be the thickness of the second conductor 42 at an area of the conductor 42 including the embossed portion 82. In some embodiments, the first thickness T1 is between approximately 0.05 mm and approximately 0.15 mm (e.g., approximately 0.10 mm). However, values of less than 0.05 mm and more than 0.15 mm are also contemplated as required for a given application. In some embodiments, the second thickness T2 is between approximately 0.10 mm and 0.30 mm (e.g., approximately 0.20 mm). However, values of less than 0.10 mm and more than 0.30 mm are also contemplated as required for a given application.

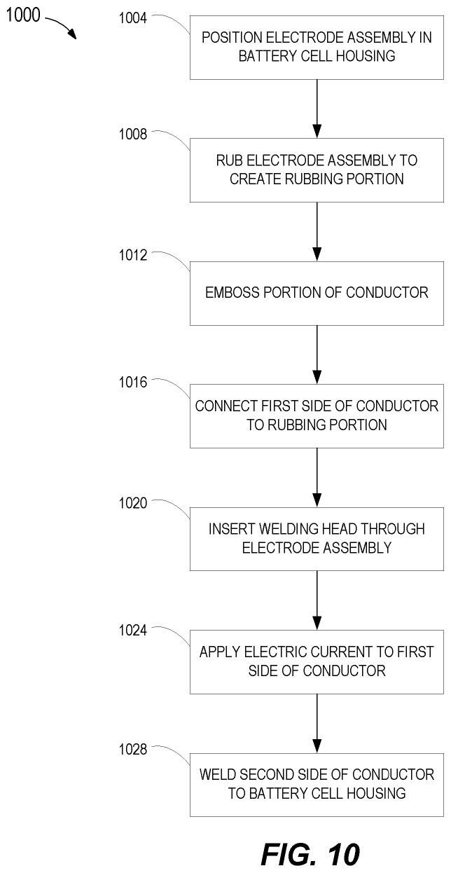

FIG. 10 is a flowchart illustrating a process 1000 for coupling the conductor to the battery cell housing 14. Each block in the process 1000 is illustrated in a particular order in FIG. 10, however, the operations may be reordered as required for a given application. At process block 1004, the electrode assembly 18 is positioned in the battery cell housing 14. At process block 1008, the electrode assembly 18 is rubbed to create the second rubbing portion 66, as described in detail above. At process block 1012, a portion of the second side 78 of the second conductor 42 is embossed. In one embodiment, the second side 78 of the second conductor 42 is embossed via a stamping operation where a force is applied to the first side 74 of the second conductor 42. In some examples, a jig or press having complementary convex and concave portions associated with the desired embossed portion may be used during the stamping process. While the process 1000 described forming the embossed portion using a stamping process, it is contemplated that other processes and/or techniques may be used to form the embossed portion as required for a given application.

At process 1016, the first side 74 of the second conductor 42 is connected. At process block 1020 a welding head, such as welding head 94 is inserted through the electrode assembly and configured to contact the second conductor 42. At process block 1024, an electric current is applied to the first side 74 of the second conductor 42 to perform a resistance welding operation. However, other welding operations or processes, such as laser welding, arc welding, friction welding, and/or other welding operations are also contemplated as required for a given application. At process block 1028, the second side 78 of the second conductor 42 is welded to the battery cell housing 14 based on the applied welding operation.

Although aspects of the present disclosure have been described in detail with reference to certain embodiments, variations and modifications exist within the scope and spirit of one or more independent aspects as described. For example, the second conductor 42 is not limited to the dimensions described above and may have dimensions greater than or less than those described in reference to FIGS. 4A and 4B. Various features of the disclosure are set forth in the following claims.

What is claimed is:

1. A battery cell comprising:
a cylindrical housing including a first end and a second end opposite the first end, wherein the second end is enclosed;
an electrode assembly positioned within the housing between the first end and the second end, the electrode assembly including an anode, a cathode, and one or more separator sheets; and
a conductor configured to electrically couple one of the anode or the cathode to the housing, the conductor including
a first side facing the electrode assembly,
a second side opposite the first side and facing the housing, and
an embossed portion for improving a welding operation for welding the conductor to the housing.

2. The battery cell of claim 1, wherein the cathode, the anode, and the one or more separator sheets are rolled in concentric layers about a central aperture.

3. The battery cell of claim 2, wherein the embossed portion is positioned at an approximate center of the conductor and is coaxial with the central aperture.

4. The battery cell of claim 1, wherein the embossed portion is positioned on the second side of the conductor and includes a plurality of convex portions.

5. The battery cell of claim 4, wherein a subset of the plurality of convex portions are configured to melt and weld the conductor to the housing in response to a welding head applying an electrical voltage to the first side of the conductor thereby causing an electrical current to flow through the conductor to the housing.

6. The battery cell of claim 5, wherein the subset of the plurality of convex portions configured to melt is dependent on a duration of time that the electrical voltage is applied to the first side of the conductor.

7. The battery cell of claim 5, wherein the embossed portion is formed by stamping on the first side of the conductor.

8. The battery cell of claim 1, wherein the electrode assembly further includes an anode rubbing portion at the second end, wherein the conductor is configured to electrically couple the anode rubbing portion to the housing.

9. The battery cell of claim 1, wherein the conductor includes three outer edges having a first width, each outer edge separated by an arc having a first radius, wherein the first width is between 3.00 millimeters and 10.00 millimeters, and the first radius is between 4.00 millimeters and 12.00 millimeters.

10. The battery cell of claim 1, wherein a total width of the conductor is between 1.50 millimeters and 4.50 millimeters.

11. The battery cell of claim 1, wherein a total length of the conductor is between 1.50 millimeters and 4.50 millimeters.

12. The battery cell of claim 1, wherein a thickness of the conductor at an area including the embossed portion is between 0.10 millimeters and 0.30 millimeters, and a thickness of the conductor at an area not including the embossed portion is between 0.05 millimeters and 0.15 millimeters.

13. The battery cell of claim 4, wherein a diameter of each of the plurality of convex portions is between 0.15 millimeters and 0.45 millimeters.

14. The battery cell of claim 1, wherein a width of the embossed portion is between 1.50 millimeters and 4.50 millimeters.

15. The battery cell of claim 1, wherein the embossed portion is formed into a square matrix of convex portions or a circular matrix of convex portions, or one or more linear matrices of convex portions.

16. A battery cell comprising:
a cylindrical housing including a first end and a second end opposite the first end, wherein the second end is enclosed;
an electrode assembly positioned within the housing between the first end and the second end, the electrode assembly including an anode, a cathode, and one or more separator sheets; and
a conductor configured to electrically couple one of the anode or the cathode to the housing, the conductor including
a first side facing the electrode assembly,
a second side opposite the first side and facing the housing, and
an embossed portion, wherein
the embossed portion is positioned on the second side of the conductor, and includes a plurality of convex portions, and
a subset of the plurality of convex portions are configured to melt and weld the conductor to the housing during a welding operation.

17. The battery cell of claim 16, wherein the conductor is a current collection plate.

18. The battery cell of claim 17, wherein the welding operation is a resistance welding operation.
